(19) United States
(12) Patent Application Publication
(10) Pub. No.: US 2026/0171534 A1
(43) Pub. Date: Jun. 18, 2026

(54) PROTECTIVE STRUCTURE FOR POUCH CELL BATTERY

(71) Applicant: GUS TECHNOLOGY CO., LTD., Taoyuan City (TW)

(72) Inventors: CHUNG CHIEH CHANG, Taoyuan City (TW); HENG CHEN KUO, Taoyuan City (TW); MING HUEI TSAI, Taoyuan City (TW); CHIH HSING LEE, Taoyuan City (TW); CHING CHI CHENG, Taoyuan City (TW)

(21) Appl. No.: 18/979,427

(22) Filed: Dec. 12, 2024

(51) Int. Cl. H01M 10/653; A62C 3/16; H01M 50/211; H01M 50/242; H01M 50/258; H01M 50/271; H01M 50/507

(52) U.S. Cl. CPC H01M 10/653; A62C 3/16; H01M 50/211; H01M 50/242; H01M 50/258; H01M 50/271; H01M 50/507

(57) ABSTRACT

The present invention provides a protective structure for a pouch cell battery, comprising a base, a top cover, and two terminal covers, wherein the base supports a battery cell module, the top cover is connected to the base, and the terminal covers are connected to both ends of the base and the top cover. The battery cell module and two bus structures are positioned between the terminal covers, with each terminal cover primarily consisting of an outer shell and an insulating interface, with each outer shell including a central through-hole. Each insulating interface is a shell-like structure made of an insulating and thermally conductive plastic material positioned adjacent to the bus structures and protruding toward the adjacent bus structures to form thermal conduction elements aligned with the respective through-holes, thereby enhancing the heat dissipation efficiency through the terminal covers.

### FIELD OF INVENTION

The present invention relates to pouch cell batteries and, more particularly, to a protective structure designed for a pouch cell battery.

### BACKGROUND OF THE PRESENT INVENTION

A pouch cell battery is a type of ion battery capable of storing and releasing significant amounts of electrical energy. Such batteries are widely used in automotive applications and energy storage systems. The ion battery types referred to herein include, but are not limited to, lithium-ion batteries.

A conventional pouch cell battery comprises a battery cell module, two bus structures, a protective case, and two electrodes. The battery cell module consists primarily of multiple battery cells arranged in parallel, each of which is used to store electrical energy. Each battery cell is equipped with two tabs which act as a positive or a negative pole. The bus structures are positioned at either end of the battery cell module, with each structure containing one or more busbars, and each tab is electrically connected to one adjacent busbar, allowing the battery cells to be interconnected in series or parallel via the tabs and the busbars. The protective case, typically made of metal, houses and secures the battery cell module while providing physical protection. Each electrode is electrically connected to one busbar and interfaces with external power transmission lines or electrical equipment. This configuration enables the battery cell module to supply power to external systems and facilitates the charging of the battery cells via the power transmission lines.

The conventional protective case comprises a base, a top cover, and two terminal covers. The base provides support for the battery cell module, while the top cover is connected to the base and positioned on the side opposite to the base, enclosing the battery cell module between the base and the top cover. Each terminal cover connects the base and the top cover at their respective ends and aligns with the bus components.

In such designs, each terminal cover is adjacent to a respective bus structure, but separated by a gap to prevent electrical contact between the terminal covers and the bus structures. While this configuration reduces the risk of electrical connection, it also limits the efficiency of heat transfer from the battery cell module to the terminal covers, particularly during charge and discharge cycles.

### SUMMARY OF THE PRESENT INVENTION

The main purpose of the present invention is to provide a protective structure for a pouch cell battery. To achieve this purpose, the present invention employs the following technical solution:
A protective structure for a pouch cell battery, designed to protect a battery cell module and two bus structures of the pouch cell battery, wherein the battery cell module is positioned between the bus structures, each bus structure comprising a supporting seat and multiple busbars, each supporting seat being formed of an insulating and thermally conductive plastic material, and each busbar being a plate made of conductive material; each supporting seat being connected to the multiple busbars on the side opposite to the battery cell module, and each busbar being electrically connected to the battery cell module;
the protective structure comprising a base, a top cover, and two terminal covers, wherein the base supports the battery cell module, while the top cover is connected to the base and positioned on the side opposite to the base, enclosing the battery cell module between the base and the top cover; each terminal cover connecting the base and the top cover at their respective ends and enclosing the battery cell module and the bus structures between the terminal covers; each terminal cover consisting of an outer shell and an insulating interface; the base, the top cover, and the outer shells being made of a flame-retardant, thermally conductive, and impact-resistant metal material;
each outer shell having a central through-hole, each insulating interface being a shell-like structure made of an insulating and thermally conductive plastic material; each insulating interface being positioned adjacent to the supporting seat on the side connected to the busbars such that the insulating interface isolates the outer shell from the busbars; each insulating interface including a thermal conduction element protruding inwardly toward the adjacent bus structure and aligned with the through-hole, enabling the heat generated by the battery cell module to be transferred externally through the thermal conduction elements and the through-holes to enhance the heat dissipation efficiency through the terminal covers; and
a thermally conductive adhesive being applied between each terminal cover and the adjacent bus structure.

The thermal conduction elements enhance the absorption of heat generated by the battery cell module and facilitate its dissipation through the through-holes in the terminal covers. This configuration significantly improves overall heat dissipation efficiency, ensuring better thermal management of the pouch cell battery.

### BRIEF DESCRIPTION OF THE DRAWINGS

FIG. 1 is a perspective view of a pouch cell battery with the preferred embodiment of the present invention;

FIG. 2 is an exploded perspective view of the pouch cell battery of the present invention showing the state without thermal conductive adhesive;

FIG. 3 is an exploded perspective view of the terminal cover in the preferred embodiment of the present invention;

FIG. 4 is a perspective view of the insulating interface of the present invention showing the side facing the bus component;

FIG. 5 is a partial sectional view of the pouch cell battery of the present invention showing the state without thermal conductive adhesive;

FIG. 6 is an enlarged partial sectional view along section 6-6 in FIG. 5;

FIG. 7 is a partial sectional view of the pouch cell battery of the present invention showing the state with thermal conductive adhesive; and

FIG. 8 is simulated temperature variations of the preferred embodiment of the present invention and a conventional pouch cell battery during discharge.

### DETAILED DESCRIPTION OF THE PREFERRED EMBODIMENTS

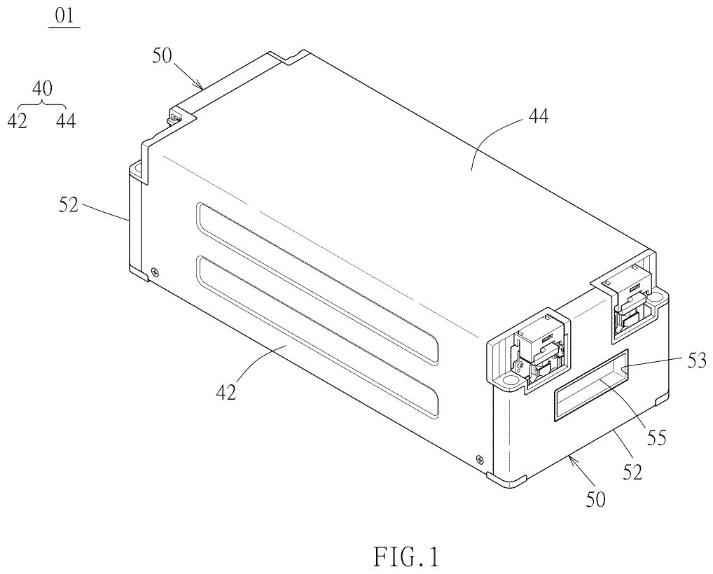

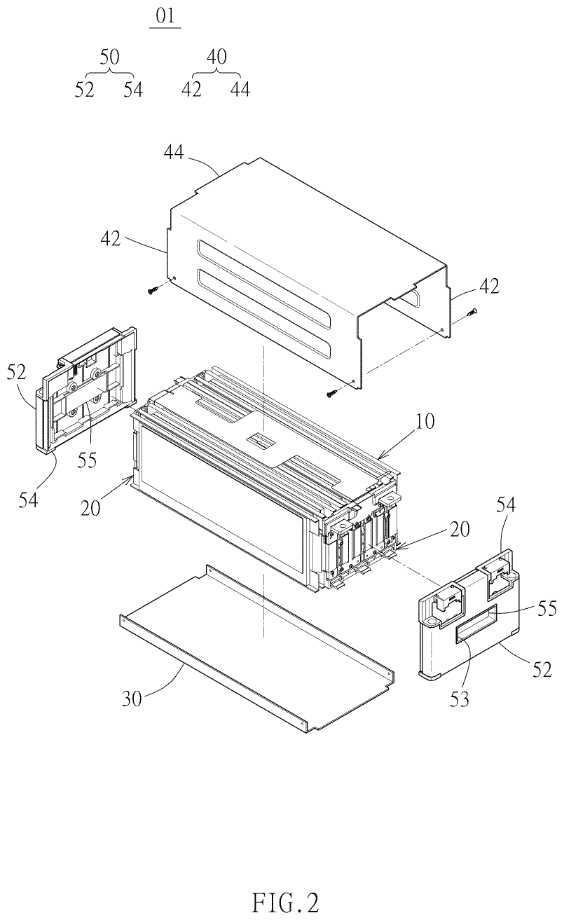

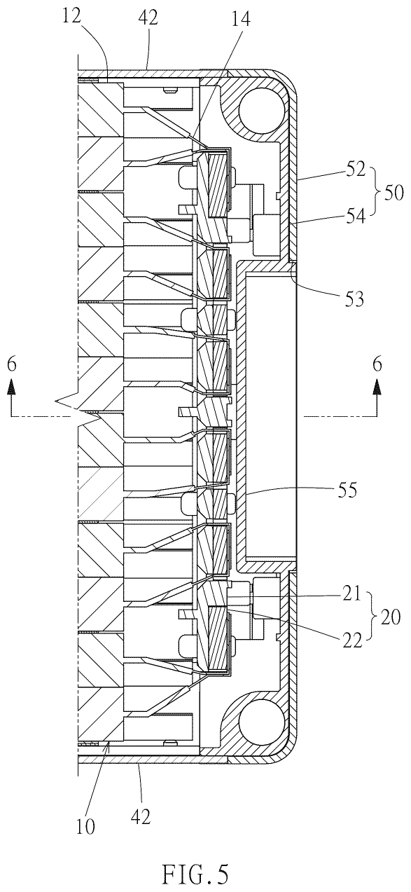

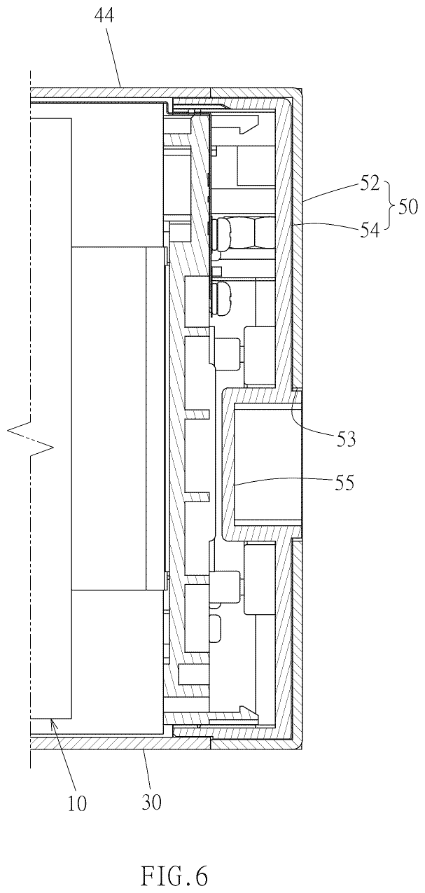

Referring to FIGS. 1 to 7, a preferred embodiment of the protective structure for a pouch cell battery according to the present invention is designed to protect a battery cell module 10 and two bus structures 20 of the pouch cell battery 01. The battery cell module 10 is positioned between the two bus structures 20, each of which comprising a supporting seat 21 and multiple busbars 22. Each supporting seats 21 is formed of an insulating and thermally conductive plastic material, while each busbar 22 is a plate made of a conductive material. Each supporting seat 21 is connected to several busbars 22 on the side opposite the battery cell module 10, with the busbars 22 electrically connected to the battery cell module 10.

The protective structure comprises a base 30, a top cover 40, and two terminal covers 50. The base 30 supports the battery cell module 10, while the top cover 40 is connected to the base 30 and positioned on the side opposite to the base 30, enclosing the battery cell module 10 between the base 30 and the top cover 40. Each terminal cover 50 connects the base 30 and the top cover 40 at their respective ends, enclosing the battery cell module 10 and the bus structures 20 between the terminal covers 50.

Specifically, the top cover 40 primarily includes two side plates 42 and a cover plate 44, which are integrally formed. The side plates 42 are arranged opposite each other, with the battery cell module 10 positioned therebetween. The cover plate 44 is located opposite the base 30, with the battery cell module 10 situated between the base 30 and the cover plate 44.

Each terminal cover 50 primarily consists of an outer shell 52 and an insulating interface 54. The base 30, the top cover 40, and the outer shell 52 are constructed from a flame-retardant and thermally conductive metal material. These components are also constructed to be impact-resistant.

Each outer shell 52 includes a central through-hole 53, and the insulating interfaces 54 are shell-like structures formed of an insulating and thermally conductive plastic material. In the preferred embodiment, the insulating and thermally conductive plastic material is a thermally conductive engineering plastic with a thermal conductivity of 1.5 to 2.0 W/mK. This material provides excellent thermal conduction properties while maintaining compatibility with standard engineering plastics. Compared to aluminum heat dissipation structures, this material reduces weight by approximately 30%. The 1 mm thick insulation material has a breakdown voltage in excess of 10,000 volts. The insulating interfaces 54 are positioned adjacent to the supporting seats 21, on the side connected to the busbars 22, thereby isolating the outer shell 52 from the busbars 22 and preventing electrical connection therebetween. In addition, the insulating interfaces 54 form thermal conduction elements 55 which protrude inwardly toward the adjacent bus structures 20. These thermal conduction elements 55 are aligned with the through-holes 53, facilitating the transfer of heat generated by the battery cell module 10 through the thermal conduction elements 55 and the through-holes 53. This configuration increases the efficiency of heat dissipation through the terminal covers 50.

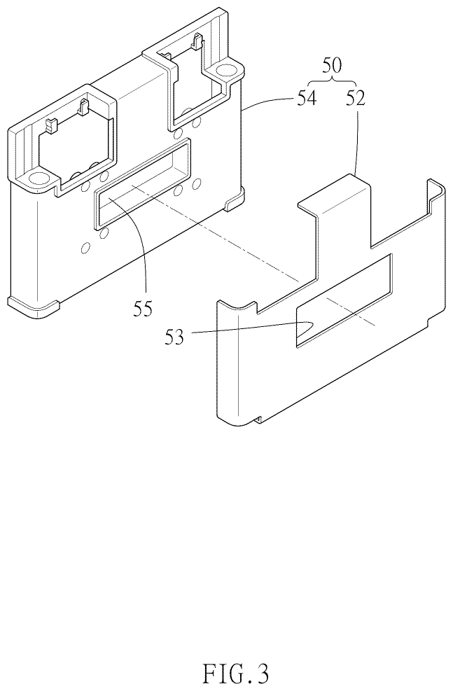

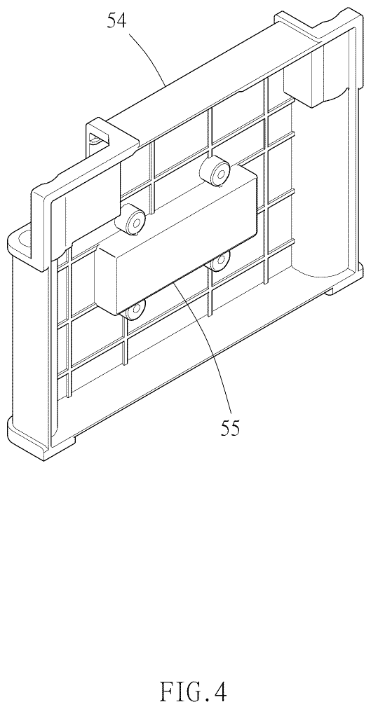

In order to meet the requirements of other components forming the pouch cell battery 01, FIGS. 3 and 4 illustrate two different shapes of the insulating interfaces 54, each of which includes a thermal conduction element 55. These insulating interfaces 54 represent different specific embodiments of the insulating interfaces described in the preferred embodiment.

Each thermal conduction element 55, oriented toward the bus structure 20, facilitates the absorption of heat generated by the battery cell module 10. While the thermal conduction elements 55 dissipate heat externally through the through-holes 53, each of the thermal conduction elements 55 can further transfer any residual heat that cannot be immediately transferred externally through the through-holes 53 within the insulating interface 54 and subsequently transferred to the outer shell 52. The outer shell 52 then assists in the external heat dissipation, further increasing the overall heat dissipation efficiency.

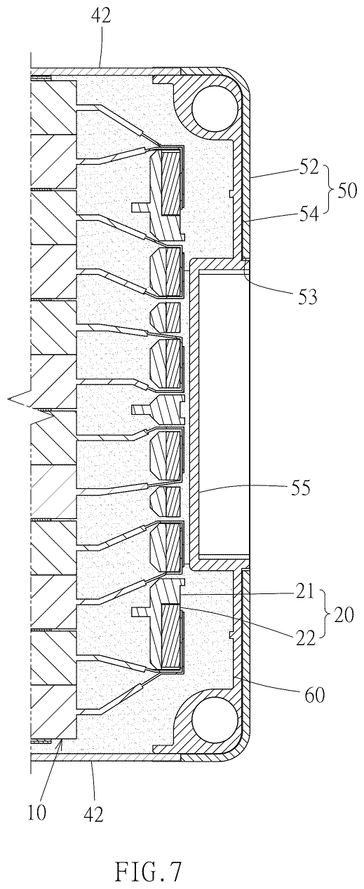

As shown in FIG. 7, a thermally conductive adhesive 60 is further applied between each terminal cover 50 and the adjacent bus structure 20. The thermally conductive adhesive 60 is made of a material with high thermal conductivity, thereby further improving the efficiency of heat transfer from the battery cell module 10 to the terminal covers 50.

The thermally conductive adhesive 60 is a material commonly known in the relevant art; therefore, its composition or specific formulation will not be described in detail herein.

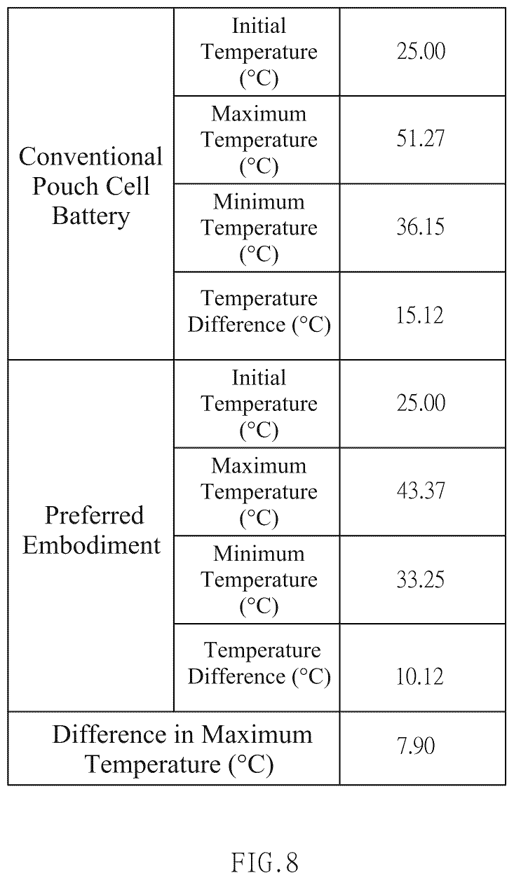

Under conditions of high charge and discharge rates, the tabs 14 of the battery cells 12 tend to experience the issues of temperature rise. In order to compare the preferred embodiment with a conventional pouch cell battery as described in the prior art, a simulation analysis was performed using a 4C discharge rate at an ambient temperature of 25° C. The results are shown in FIG. 8. Unlike the preferred embodiment, the conventional pouch cell battery does not include the insulating and thermally conductive plastic insulating interfaces 54 or the thermally conductive adhesive 60.

Referring to FIG. 8, the maximum temperature observed in the preferred embodiment is 43.37° C. compared to 51.27° C. in the conventional pouch cell battery, indicating a reduction of 7.90° C. This demonstrates that the preferred embodiment significantly improves heat dissipation through the insulating interfaces 54 and the thermally conductive adhesive 60. Furthermore, the temperature difference between the maximum and minimum temperatures in the preferred embodiment is 10.12° C. compared to 15.12° C. in the conventional pouch cell battery. This reduced temperature variation minimizes battery aging and improves safety and reliability.

What is claimed is:

1. A protective structure for a pouch cell battery, designed to protect a battery cell module and two bus structures of the pouch cell battery, wherein the battery cell module is positioned between the bus structures, each bus structure comprising a supporting seat and multiple busbars, each supporting seat being formed of an insulating and thermally conductive plastic material, and each busbar being a plate made of conductive material; each supporting seat being connected to the multiple busbars on the side opposite to the battery cell module, and each busbar being electrically connected to the battery cell module;
the protective structure comprising a base, a top cover, and two terminal covers, wherein the base supports the battery cell module, while the top cover is connected to the base and positioned on the side opposite to the base, enclosing the battery cell module between the base and the top cover; each terminal cover connecting the base and the top cover at their respective ends and enclosing the battery cell module and the bus structures between the terminal covers; each terminal cover consisting of an outer shell and an insulating interface; the base, the top cover, and the outer shells being made of a flame-retardant, thermally conductive, and impact-resistant metal material;
each outer shell having a central through-hole, each insulating interface being a shell-like structure made of an insulating and thermally conductive plastic material; each insulating interface being positioned adjacent to the supporting seat on the side connected to the busbars such that the insulating interface isolates the outer shell from the busbars; each insulating interface including a thermal conduction element protruding inwardly toward the adjacent bus structure and aligned with the through-hole, enabling the heat generated by the battery cell module to be transferred externally through the thermal conduction elements and the through-holes to enhance the heat dissipation efficiency through the terminal covers; and
a thermally conductive adhesive being applied between each terminal cover and the adjacent bus structure.
